(19) United States
(12) Patent Application Publication
(10) Pub. No.: US 2017/0140221 A1
(43) Pub. Date: May 18, 2017

(54) DUAL FUNCTION CAMERA FOR INFRARED AND VISIBLE LIGHT WITH ELECTRICALLY-CONTROLLED FILTERS

(71) Applicant: INTEL CORPORATION, Santa Clara, CA (US)

(72) Inventors: MIKKO OLLILA, Tampere (FI); ENDRE VEKA, Portland, OR (US)

(73) Assignee: INTEL CORPORATION, Santa Clara, CA (US)

(21) Appl. No.: 14/941,216

(22) Filed: Nov. 13, 2015

(51) Int. Cl. G06K 9/00; G02F 1/135; H04N 5/33; G02B 27/58; G02F 1/1347; G02B 13/14; G02F 1/157

(52) U.S. Cl. CPC G06K 9/00604; G02B 13/14; G02F 1/135; G02F 1/157; G02B 27/58; G02F 1/13473; H04N 5/33; G02F 2201/44; G02F 2203/11; G02F 2203/58

(57) ABSTRACT

A dual function camera is described for infrared and visible light imaging using electrically controlled filters. An example has an image sensor to image visible and infrared light, a lens system to image a scene onto the image sensor, and an electrically activated filter that selectively prevents visible light from the scene from impinging on the image sensor while capturing an infrared image.

### FIELD

The present description pertains to the field of iris recognition for authentication and in particular to a camera for both iris scanning and visible light photography.

### BACKGROUND

In some high security installations, an image of the iris of a person is captured by a camera in order to allow or permit access to a building, an area, or equipment such as a computing console. A person's iris is more unique than a person's fingerprint and an iris scanner is harder to fool than a fingerprint reader. While such systems are often referred to as iris scanners, modern versions are more commonly in the form of infrared cameras. The modern system is typically large and expensive because it requires an infrared light to illuminate the eye and a camera capable of capturing an infrared image with enough detail to make a reliable authentication determination. Infrared light provides a much more detailed image of an iris than does visible light. In addition, an imaging processor is used to compare the captured iris with stored approved images and to determine if there is a match. Some sort of estimation process is used to account for dirt on a user's eyeglasses, contact lenses, eye diseases, broken blood vessels in the eye, variations in lighting, and other factors that may change the appearance of the iris.

Iris scanning is available as an additional authentication, password, or other security feature in smart phones and may be extended to other types of portable and handheld devices including computers. The iris scanner may be used as a supplement or as an alternative to fingerprints and other biometric authentication systems. Smart phones add iris scan by adding a front facing near infrared (IR) camera to the front side of the mobile device next to the normal front facing “selfie” camera and an IR lamp to illuminate the iris. The IR iris camera uses a special IR pass filter while the normal camera uses a visible light spectrum pass filter. The authentication process is performed using the processing and memory resources already available on the smart phone.

A large, slow, high power iris scanning system may further enhance security for a building by also slowing access. These same characteristics may render a handheld or portable device frustrating to use. For smart phones and notebook computers, the trend is for small, fast, low power systems that provide only a very small obstacle to using the device. The conventional fixed installation is not suitable for use as an add-on to the portable or battery-power device.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a block diagram of an iris recognition system with a dual function user-facing camera according to an embodiment.

FIG. 2 is a diagram of a portable device incorporating dual function user-facing camera according to an embodiment.

FIG. 3 is a side view diagram of an example of a dual function camera module with two apertures according to an embodiment.

FIG. 4 is a side view diagram of an example of a dual function camera module with two apertures in a single aperture mask according to an embodiment.

FIG. 5 is a diagram of depths of field for two apertures of a dual function camera module according to an embodiment.

FIG. 6 is a side view diagram of an example of a dual function camera module with two apertures and an electrically controlled filter according to an embodiment.

FIG. 7 is a side view diagram of an example of a dual function camera module with two apertures in a single aperture mask and an electrically controlled filter according to an embodiment.

FIG. 8 is a side view diagram of an example of a dual function camera module with two apertures and an electrically controlled filter with an apodized IR aperture according to an embodiment.

FIG. 9 is a side view diagram of an example of a dual function camera module with two apertures in a single aperture mask and an electrically controlled filter with an apodized IR aperture according to an embodiment.

FIG. 10 is a side view diagram of an example of a dual function camera module with two apertures formed on an electrically controlled filter with an apodized IR aperture according to an embodiment.

FIG. 11 is a graph of responses of different LC films as a function of an applied voltage.

FIG. 12 is a side view diagram of an example of a dual function camera module with two apertures and an electrically controlled cemented electro-chromatic filter according to an embodiment.

FIG. 13A is a side view diagram of an example of a dual function camera module with two apertures integrated into an electrically controlled electro-chromatic filter with an apodized IR aperture according to an embodiment.

FIG. 13B is an enlarged view of the electro-chromatic filter of FIG. 13A.

FIG. 14 is a side view diagram of an example of a dual function camera module with an electrically controlled filter according to an embodiment.

FIG. 15 is a process flow diagram of operating a dual function according to an embodiment.

FIG. 16 is a block diagram of a computing device incorporating IR lamp enhancements according to an embodiment.

### DETAILED DESCRIPTION

Iris recognition systems use an infrared (IR) camera to capture an image of one or both retinas or to scan one or both retinas. A variety of different camera configurations may be used. While scanners have been used commonly, rolling shutter cameras are now available in compact and low priced systems. CMOS (Complementary Metal Oxide Semiconductor) and CCD (Charge Coupled Device) image sensors are both very sensitive to infrared light so an infrared camera is easily made using existing sensors and an infrared light pass through filter. A clear picture of an iris is more reliably obtained when an IR LED (Light Emitting Diode) lamp or projector is used to light the human iris. The iris texture is easiest to detect when the light spectrum is around 820 nm.

An additional IR camera adds to the cost and size of the total camera system of a device. However the visible light, user-facing or “selfie” camera and the iris camera have very different performance requirements. There are differences in the desired depth of field and focus distance. A camera which has one aperture that defines the DOF and light transmission for both applications would work poorly for both applications. If it is designed to capture images for one application, then it may not work at all for the other one.

For the standard visible light or RGB user-facing camera, the focus distance is typically about 40 to 50 cm so that a user's head and shoulders are easily captured at arm's length. This is also a comfortable distance for video conferencing. A large aperture is used so that images may be captured in low light. For the iris camera, the focus distance is typically about 25 cm. The closer distance allows the user's eye to cover more of the camera's field of view and makes it easier for the user to accurately aim the camera at the eye.

The closer distance also helps to ensure that there are enough camera pixels available, e.g. 150 pixels or more, to reliably detect the iris. A closer distance may serve still better but may be uncomfortable and awkward for users. In order to have enough pixels for iris detection at a focus distance of 50 cm, a much higher resolution sensor and a corresponding longer focal length lens would be needed. This increases the sensor and camera module cost. It would also increase the size of the camera module which may not be feasible for thin devices.

The conventional user facing camera lens has an aperture or f stop number of f:1.7-f:2.8 or less. The depth of focus or depth of field for a typical user facing camera at a distance of 25 cm is so narrow that it may be difficult for a user to position the camera so that the iris is in focus. This may discourage use of the iris recognition system. A smaller aperture with the same lens, e.g. f:4-f:11 would provide a much greater depth of field so that objects from e.g. 15-100 cm are in focus. In this case, the user only needs to aim the camera properly. The distance between the camera and the eye is no longer a large obstacle to using the system.

Accordingly, a large aperture or small f number lens is better for the user facing or front facing visible light camera because this provides for good low light performance. A large aperture lens is not needed for an IR (infrared) iris camera because an IR LED is typically used with the IR camera to supply any needed illumination. The IR LED is inexpensive and provides an important function of overpowering background infrared sources. The camera image uses the controlled IR LED illumination rather than the unknown and inconsistent background illumination. At the same time the IR LED may be used to provide extra light needed for the smaller aperture. At close distances, such as 25 cm, the amount of additional light needed for an f:11 exposure compared to an f:2 exposure is well within the range of commonly used LEDs.

An additional effect of the smaller IR aperture is that the effect of background illumination is reduced. An f:8 exposure will allow only 1/16 of the ambient light allowed by an f:2 exposure. The LED light will compensate for the ambient light difference by providing the additional light. As a result, the impact of any background IR illumination is much reduced compared to the LED light and a more reliable iris image is captured.

In addition, when iris recognition is used to unlock a phone or other mobile device, the iris recognition needs to operate reliably and across a large temperature range. With many inexpensive and small lens systems and camera modules, the focus distance drifts with temperature. At close focus distances and large apertures, the focus drift is significant. At longer focus distances, e.g. 50 cm, the impact of this drift is much less. A small aperture for the iris recognition camera may be used to mitigate the effects of the focus drift by providing a larger depth of field over all temperatures. This allows a less expensive plastic lens system to be used.

As an example, if a user leaves the device in a car or uncovered at a beach, the device may become so hot that it is no longer able to perform iris recognition. This would render the device unusable until it cools. Similarly if the device is left outside at a snow skiing location, it may become unusable until it is heated to nominal conditions. This may cause a great inconvenience to the user. Cheap plastic lens systems have a large thermal focus drift but, with the described dual aperture system, the resulting large DOF minimizes the effect of thermal drift for the IR functions. For the visible light system the impact of focus drift is less important. While the visible light camera may not be able to provide focused close up pictures, distant objects may still be imaged even before the device reaches its nominal temperature.

As described herein a single camera module with only one lens may be used for both the user facing camera and the iris recognition camera. The described lens system has one aperture for infrared light and another aperture for visible light. A single image sensor captures both the IR and visible images. The system may be augmented with more precise sharp cut-off filters. The visible light or RGB images benefit from a sharp cut off filter to eliminate infrared light. Similarly, the iris camera benefits from a sharp filter cut-off filter to eliminate ambient IR and visible light such as excess sunlight.

In some embodiments, an LC (Liquid Crystal) filter is used as a spectrum selective filter. When the RGB or visible light function is used, the LC filter may be configured to filter out the IR band. When the IR function is used, the LC filter may be configured to filter out the RGB band. Many LC films may be configured to reflect certain frequencies once activated. Multiple films may be selectively activated to control the frequencies that are reflected and the frequencies that are passed.

In some embodiments, a tunable IR cut-off filter is provided using an electro-chromatic filter on top of or within the lens of a camera module. The electro-chromatic filter may be designed so that it switches between passing either visible or IR light at any one time but not both. A standard RGB+IR dual band pass filter may be added to eliminate all other light wavelengths.

In some embodiments, instead of having only one aperture for the shared lens, two apertures are placed over or within the lens system of the camera module. The first larger aperture defines an opening that is transmissive for both visible and IR light. This aperture is used for the standard user-facing camera photography and video. The second smaller aperture rejects the IR spectrum of light except through a smaller opening. In other words, visible light passes through the second smaller aperture and the surrounding aperture mask unaffected while IR light is restricted to the opening of the smaller aperture. This provides a smaller aperture for IR imaging.

In some embodiments, the smaller IR aperture has a gradual change in transmission for IR or both for RGB and IR. A clear aperture may cause diffraction at the sharp edge of the opening when the opening is small. The diffraction will reduce the resolution or clarity of the image. An apodized or gradual aperture provides higher resolution with smaller apertures. The gradual transmission change may be Gaussian to give the best resolution or some other transition to suit the particular materials being used. The gradual transmission change of an apodized aperture effectively creates a large DOF and high resolution for IR light. These characteristics allow the lens design to be simplified for iris recognition to operate over various thermal operation conditions. These characteristics also allow less precise manufacturing tolerances to be used in producing the lens system. Apodization may easily be included also as part of an electro-chromatic filter

Using two fixed apertures in which the smaller aperture always filters out IR light but admits visible light, always reduces the IR light for visible light imaging. This may enhance the quality of visible light images. The unwanted behavior and impact from IR light to the IQ (Image Quality) is reduced. The image sensor for any of the described lens systems may be a normal RGB photodetector sensor such as a CMOS (Complementary Metal Oxide Semiconductor) sensor because all of the color filtered pixels are also sensitive to IR. Alternatively, a specialized sensor that has some pixels for visible light and other pixels for IR may be used. In one such example, the sensor uses a Bayer pattern modified so that half of the green pixels are changed to IR pixels. In some embodiments, the information captured by the IR pixels may be used to adjust the visible light pixels. Since the impact of the IR light on the RGB pixels is known from the IR pixels, this unwanted IR light impact may be taken into account in the conversion from pixel values to color image.

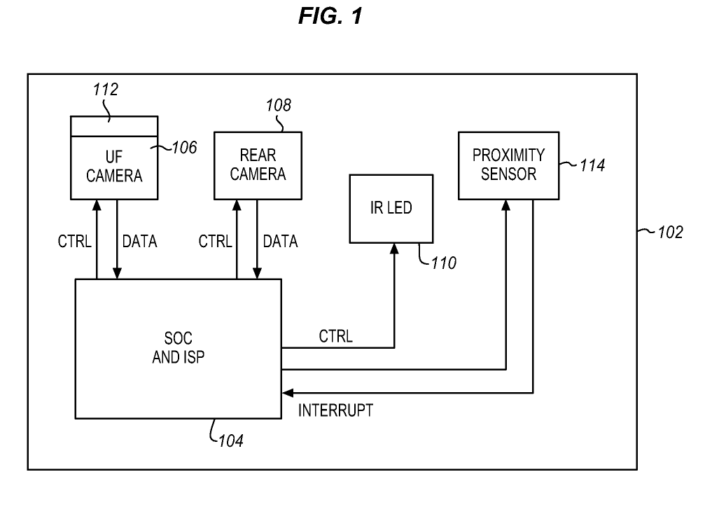

FIG. 1 is a block diagram of parts of a portable device, such as a smart phone, a notebook computer, a tablet, a point of sale terminal, or a wearable with an iris recognition system. The iris recognition system may be used for user authentication, login, purchases, and other purposes. The device 102 uses an SOC (System on a Chip) 104 with an integrated central processor, ISP (Image Signal Processor), and memory. The SOC is coupled to a primary UF (User Facing) and IR camera 106 and one or more main high resolution rear cameras 108. The SOC controls the operations of the cameras using a control line to each camera and receives images from the cameras over a data line from each camera for processing by its internal ISP. The connections are shown for illustration purposes. There may be many parallel lines, a shared bus or a variety of other types of connections between the cameras and the SOC. There may also be additional interface and other intermediate devices between the cameras and the SOC.

In some embodiments a color filter 112, such as an LC or electro-chromic filter is placed over or within the user facing camera. This filter may also be controlled by the SOC. While an SOC is shown, any of a variety of different system architectures may be used with more or fewer components. The system may also include a larger mass memory, additional sensors, user input devices, wired and wireless data interfaces, and actuators as well as displays and a battery, among other components.

In addition the system includes an IR lamp with an LED 110 or other source of IR light. The IR lamp is controlled by and coupled to the SOC so that the operation of the IR lamp may be coordinated with the operation of iris recognition by the user facing camera. An optional proximity sensor 114 is also coupled to the SOC. There may also be additional components, not shown here in order to simplify the drawing including a user facing visible light LED or other illumination source for the UF camera, and a flash or lamp for the one or more rear facing cameras. The device may also include additional cameras on other surfaces of the device, position and motion sensors and more.

A proximity sensor provides a very low power but imprecise component to determine distance and the nearness of another object. The same functions may instead be performed by the user facing camera 106. Alternatively, the proximity sensor may include a rangefinder or distancing system to not only detect the presence of something near the sensor but also to determine its approximate distance. The proximity sensor may also be substituted with a low resolution camera. Such a camera may be used to provide depth information for use with the regular UF or IR camera. The proximity sensor may also be used in addition to any one or more of these components.

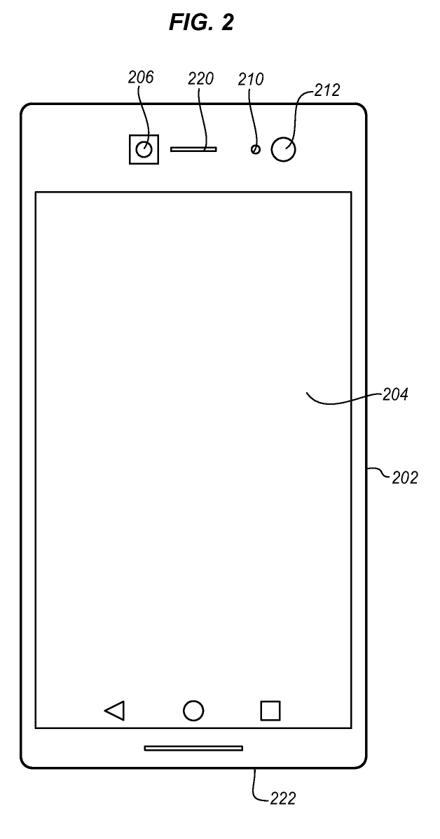

FIG. 2 is a diagram of an exterior front surface of a handheld device, such as a smart phone, similar to that of FIG. 1. The device may be a smart phone, a tablet, a portable computer, a smart watch or it may be adapted into any of a variety of other form factors and configurations. The device 202 includes a display 204 which may include a touch interface for user input. On one surface of the device, proximate the screen, a primary user facing (UF) camera 206 is mounted. The UF camera is directed in the same direction as the display and is able to capture images of the user when the user is in front of the screen. The UF camera may also display images that it captures on the display. The UF camera includes IR camera capabilities as described herein. The system may also include additional features near the UF camera. In this embodiment a proximity sensor 210, an IR lamp 212, and a speaker 220 are shown. There may be additional cameras on this surface and other surfaces (not shown) as well as additional lamps, camera flash LEDs, and other sensors.

The system also includes a microphone 222 as shown. There may be multiple speakers and microphones on this and other surfaces. The device may also have buttons and ports (not shown) for additional functions as well as keyboards, connectors, and other input and display devices, depending on the particular implementation. While the cameras, proximity sensor and IR lamp are shown as all being on the same one edge of the screen, they may be placed in other positions to suit different form factors and user activities. In addition, as mentioned above, the cameras, proximity sensor, and lamps may be combined in different ways to provide a more compact or less expensive device.

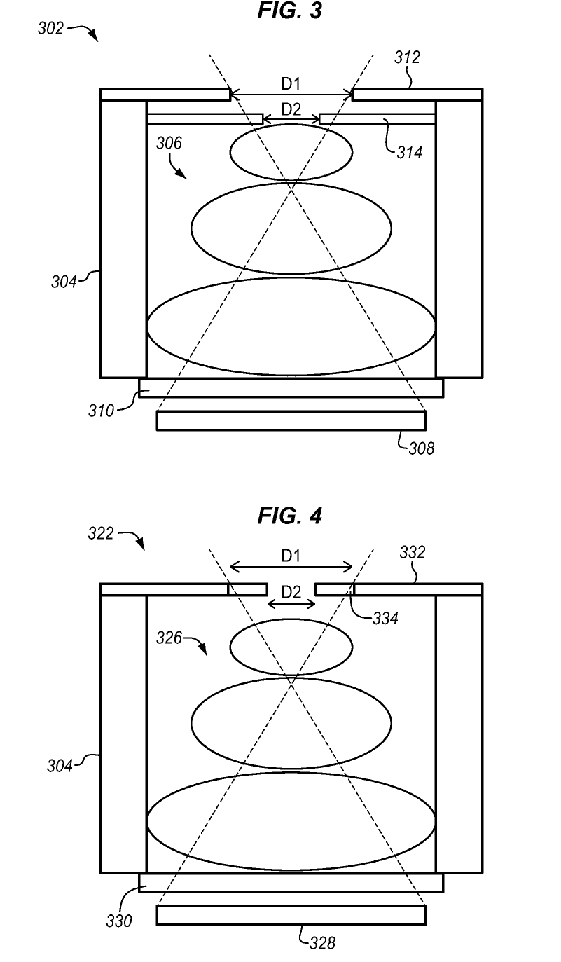

FIG. 3 is a side view diagram of an example of single camera module 302 with two apertures 312, 314. The apertures are shown as fixed both in size and in position, however, variable apertures may be used. Because the apertures are fixed, they are always affecting the light that comes through the lens onto the sensor. The camera module has a housing 304 to retain and hold an optical lens system 306 and an image sensor 308. Light from a remote scene passes through the apertures and the lens system to impinge on the image sensor. The image quality is optionally improved by an RGB and IR bandpass optical filter 310 between the lens system and the image sensor. This filter allows only visible light and a narrow band of IR light to pass through to the image sensor. The filter may be placed in any other location in the camera module 302. As shown, the camera module has a fixed aperture, fixed focus lens. The aperture is set to some large f number aperture of f:4 or less. Typical current cameras on smart phones, tablets, and similar types of portable computing devices have apertures of about f:2, usually from f:1.7-f:2.8. The focus distance is set to about 50 cm for video conferences and user portraits. Such a camera is readily available at low cost, however, a more complex and more capable camera module may be used with auto-focus, variable aperture, and other features, depending on the application.

The lens system 306 is shown as having three elements, however, this is only for illustration purposes. The principles described herein may be applied to simpler and more complex lens systems. A fixed focus, fixed focal length lens system is attractive for its simplicity and low price. However the lens system may have variable or auto focus and may have a zoom mechanism to modify the focal length. Other substitutions or modifications may be made to the lens system to suit different intended uses, form factors, and price points.

The image sensor 308 may incorporate a shutter mechanism such as a rolling shutter or global shutter or a separate shutter mechanism (not shown) may be used by the camera module 302. The image sensor 308 captures both visible light and IR light to produce images from both. A variety of different image sensor configurations may be used. In a typical CMOS image sensor, there are millions of discrete photo receptor sites which capture light to form the pixels of the final image. Each site is covered by a color filter. The color filter allows either red, green, or blue light to pass through to the respective photo receptor, although other colors may be used instead. Such a sensor may be adapted so that some of the sites use IR filters or it may be adapted so that all of the sites collect IR light together with the red, green, or blue light. In one example, the color filters are arranged in a modified RGGB or Bayer pattern so that some of the green pixels are changed to IR pixels by changing the filters. Other configurations may be used depending on the particular implementation.

The camera module also includes two aperture masks 312, 314 above the lens system 306. The top mask 312 has a large aperture with a corresponding large diameter D1. This aperture may be on the order of f:2 or larger, depending on the implementation. This mask blocks the visible and IR light and may be made of a solid material that blocks all light. The large aperture may be a part of the housing 304 or a separate aperture mask may be attached to the housing. It may be in the form of a hood or shroud to protect the imaging system from stray light. The aperture mask may be formed of a solid or opaque sheet with an appropriate circular hole cut into the sheet so that an aperture formed by the hole is centered over the lens system when it is installed in place over the lens system. Alternatively, the aperture mask may be made from a solid sheet of transparent material such as plastic, silica, or glass. The center is uncoated or coated with an anti-reflective (AR) or other filter, film, or coating. The outer portion outside of the aperture is coated with a reflective or absorbing film that reflects or absorbs all light to which the image sensor is sensitive. Such a solid aperture mask may serve also as a protective cover for the system. The aperture may be circular or it may be a shape that is better suited to the shape of the image sensor.

The second mask 314 has a much smaller aperture with a smaller diameter D2. This aperture may be on the order of f:8 or smaller, depending on the implementation. The second mask blocks only IR light so that the visible light is not affected. The visible light will pass through the second mask as well as through the aperture of the first mask unaffected. The IR light on the other hand is restricted to the small D2 aperture.

This mask may similarly be formed of a solid material with a hole cut in the middle. The solid material is a material that is transparent to visible light but that reflects or absorbs infrared light. Alternatively, the aperture mask may be made from a solid transparent sheet with a central area that is transparent to IR and visible light and then a coaxial, annular area surrounding the central area that is transparent to visible light but not transparent to IR light. There may be an additional optional coaxial outer annular area that is opaque to both IR and visible light. This may be used to structurally reinforce the first aperture mask or to reduce internal coatings. The selective transmission of the circular areas may be produced using coatings, films, or layers, as may be suitable for particular implementations. The interior of the housing 304 may also be treated with anti-reflective coatings or materials to reduce internal reflection within the housing.

While the aperture masks are shown as being over the front of the lens system, they may be placed in another location, depending on the design of the lens system 306. In one example, the aperture masks are placed at an aperture stop of the lens system.

As a result, the lens system presents two different sized simultaneous apertures, one for visible light and the other for IR light, without any moving parts. The same fixed focus lens may be used as a large aperture visible light lens and as a small aperture IR lens. Both apertures are functional and operative at the same time so that a visible light image and an IR light image may be captured simultaneously or at different times. The camera module may also include processing, timing, command and control resources that are not shown here in order to simplify the drawing figure.

FIG. 4 is a side view diagram of an alternative camera module configuration. In this camera module 322, a housing 324 carries a lens system 326 and an image sensor 328 with an optional RGB+IR pass filter 330 in between. These components are similar to those of FIG. 3. In this example, a single aperture mask includes both the large visible light aperture 332 and the smaller IR light aperture 334 in a single mask. Such a single aperture may be produced using solid materials or materials with apertures cut through them as described above. In another modification, the two aperture masks of FIG. 3 may be cemented together to form a single laminar structure.

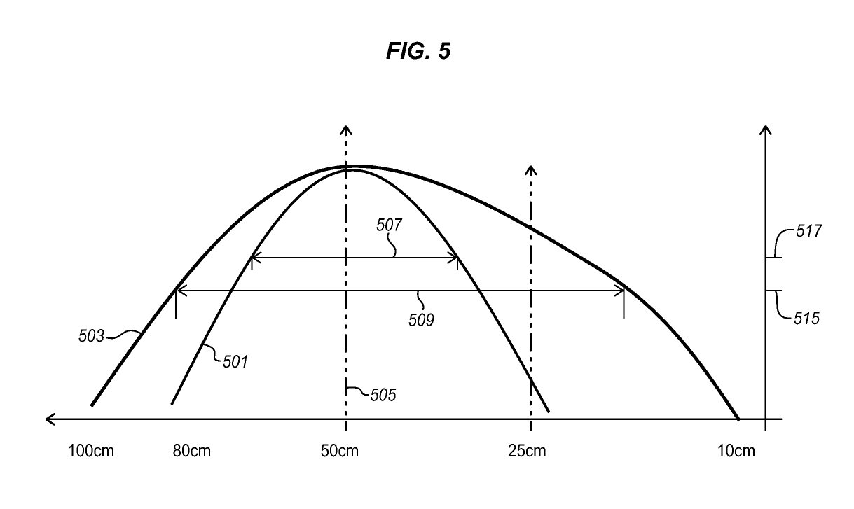

FIG. 5 is a diagram of depth of field for an example camera module at two different apertures. The focus distance is indicated on the horizontal scale and the sharpness or resolution is indicated on the vertical scale. Two values of acceptable sharpness are designated on the vertical sharpness scale. A first value 515 indicates the acceptable sharpness for an iris scan image. The second higher value 517 indicates the acceptable sharpness for a color photograph or video conference. These two values may alternatively be the same. The specific values are subjective and indicate what is considered “acceptable.” The values will depend on the quality of the lens and sensor as well as the quality and accuracy desired for the iris recognition system.

A single lens system has been focused to a distance of 50 cm 505 on the horizontal distance scale. As indicated this is a suitable distance for video conferencing, frame-filling self-portraits and other common visible light pictures. A first curve 501 shows the depth of field for the lens at the maximum aperture, in this case f:2.2. A second curve 503 shows the depth of field for the lens at a second smaller aperture, in this case f:11. The particular curves and scales will depend on the size of the image sensor, the focal length, the focus distance of the lens, and the particular selected apertures.

The large aperture curve 501 has a narrower depth of field range. Maximum sharpness for an image is produced at the focus distance 505. The sharpness reduces in both directions from that maximum at the focus distance. For the higher sharpness requirements of the visible light image, the depth of field curve passes the higher sharpness threshold 517 to provide a depth 507 from about 30-70 cm. At the preferred distance for iris recognition 25 cm, the sharpness is well below the lower sharpness threshold 515. As a result, such a single focus, large aperture camera module cannot be used both for normal visible light uses and for iris recognition.

The second smaller aperture curve 503 shows a much larger depth of field even at the higher quality threshold. At the lower sharpness threshold 515, the depth of field is from about 18-90 cm. As a result, it will be very easy for the device to obtain sufficient sharpness for the iris image. The desired sharpness at distances of about 25 cm occurs even though the lens is focused at 50 cm.

As shown, the IR light has a large depth of field due to the smaller aperture which results in a longer working range, in this example from about 18-90 cm. As a result, even with cheaper all plastic optics, the depth of field may be enough to compensate for the thermal drift in focus distance. For visible light, a large aperture of about f:2.0 is desired to provide good low light performance. The depth of field is much too narrow and thermal focus drift may make the sharpness even worse so that iris scanning would not be possible.

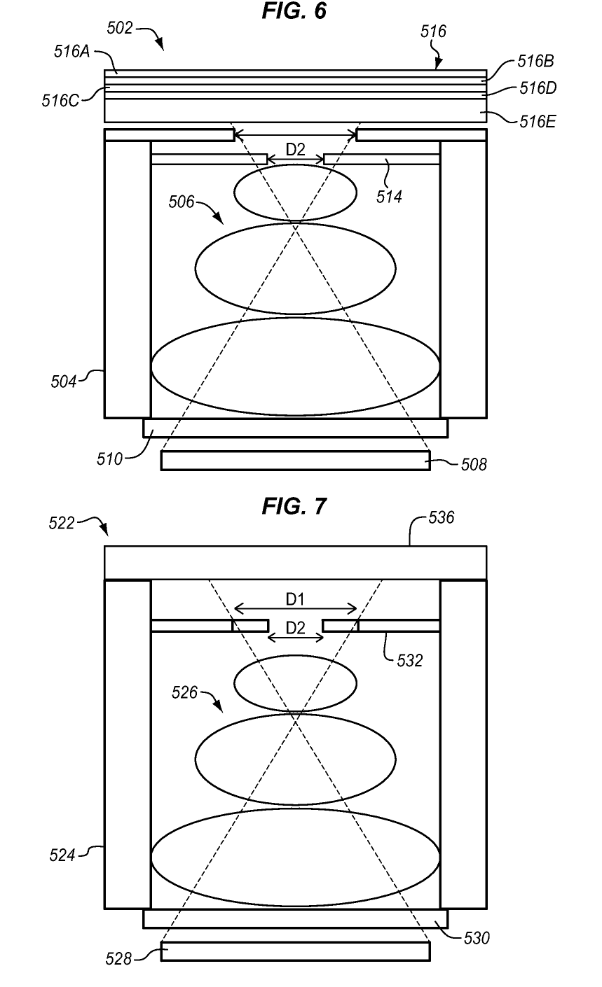

FIG. 6 is a side view diagram of an alternative camera module configuration. In this example a liquid crystal (LC) filter 516 is used to seal the camera module 502. The LC camera operates so that when the user-facing or selfie camera mode is used, the LC filter is set to pass the visible light (RGB). When only IR light is needed, the LC filter is controlled in a way so that it only passes IR. If the LC filter is not precise in filtering specific visible and IR wavelengths, then an RGB+IR dual bandpass filter 510 may be used to add accurate and steep light wavelength filtering.

More specifically, the camera module 502 includes a lens system 506 to focus light through an RGB+IR filter 510 to an image sensor 508. The image sensor captures both RGB and IR light and may have any of the different formats described herein. These components are carried in a housing 504. A two aperture system is also attached to the front of the lens or to another suitable location in the lens system. One aperture is defined by a first aperture mask 512 that has a large aperture D1, e.g. about f:2, for passing visible and IR light through the aperture and blocking the light outside the aperture. A second smaller aperture D2, e.g. about f:8-f:11, is defined by a second aperture mask for passing IR light through the aperture without affecting the visible light, as described, for example, in the example above.

The LC film 516 is applied to a substrate and mounted above the aperture masks or between the aperture masks and the scene. The LC film is controlled by a camera module controller or by a separate ISP to selectively allow and restrict either visible spectrum or narrowband IR light from a scene through the aperture masks and the lens system to the image sensor.

A thin liquid crystal layer (e.g. about 5 μm thick) can be made reflective for certain wavelengths by selecting an excitation frequency and a voltage to be applied to the material by a controller. The LC material, the crystal alignment and the thickness of the layer will also affect the bandwidths that are reflected. If the drive frequency applied to the LC layer is changed then the material changes to from transparent to scattering. If the excitation is disabled, then the LC layer changes to fully transmissive for all bandwidths. LC layers have a polarizing effect so the reflectance is only for one direction of polarization and for only half of the impingent light. Another LC layer with a perpendicular polarization may be added to provide 100% reflectivity. Different LC layers may be used for different light wavelengths or a single LC layer may be used for both visible and IR by changing the excitation frequency and voltage. LC layers may be used to reject even light wavelength bands as narrow as 10 nm. This may be particularly effective for blocking the intended narrow near IR band for the iris imaging functions.

FIG. 6 shows an enlarged view of the LC film 516 as actually containing four separate LC layers. Each layer may have two components each for a different polarization. As an example, within one layer there may be a vertical polarization component and a horizontal polarization component. The LC film has a red reflecting layer 516A, a green reflecting layer 516B, a blue reflecting layer 516C, an IR reflecting layer 516D, and a supporting substrate 516E. The substrate may have additional anti-reflective and other coatings. It may also be coated to define the circumference of the visible light aperture.

FIG. 7 is a side view diagram of an alternative camera module configuration in which the two aperture masks are combined so that both apertures are formed on the same mask 532. As in FIG. 6, the aperture mask, lens system 526, bandpass filter 530, and image sensor 528 are held in place and attached to a housing 522 for the camera module 524. The LC film 536 is attached over the top of the lens system although it may be placed in another location, depending on the implementation. There may be additional substrates and lenses as with the other illustrated embodiments.

In the examples described herein, only one camera module and only one optical lens system with two apertures are required to perform both visible and IR light imaging, such as user facing visible light imaging for video conferences and iris recognition. The lens system aperture system has two apertures. As with the above examples, the larger aperture mask reflects or absorbs all relevant light and transmits both visible and IR light through the aperture. The smaller aperture mask transmits visible light through the mask and the aperture and transmits IR light only through the smaller aperture. The apertures may be formed in one or two separate substrates. A clear aperture may be used for one or both of the apertures. Alternatively, an apodized aperture may be used. An apodized aperture has gradually changing transmission across the edge of the aperture without a clearly defined edge and may help to reduce diffraction for the smaller IR aperture. A clear aperture or one with apodized characteristics may be used for one or both light wavelength bands.

As described, only one camera is used for iris scan and for normal imaging instead of two separate modules. This reduces the amount of space required for the two functions and can also reduce the cost. Not only is the cost of the module avoided but also the cost of connections, switching, and ports and interfaces to other components. Power is also saved by never supplying power to a second module.

FIG. 8 is a side view diagram of an alternative camera module similar to that of FIG. 7 with an apodized IR aperture in the form of a coating. In this example, the camera module 542 includes a housing 544 to carry a lens system 546 a pass filter 550 and an image sensor 548. An LC film 556 is mounted over the lens to select visible, IR or both. A top aperture mask 552 has a large aperture for visible light and a smaller aperture 554 has a smaller apodized aperture for IR light.

The smaller IR aperture mask may be formed by a coating on a substrate. The coating material absorbs visible and IR light. Up to the edge of the smaller aperture of diameter D2, a coating material is applied that absorbs IR light. The IR light is only allowed to pass through the second smaller aperture. The IR absorbing material may be applied in a gradually thickening or more gradually more effective layer so that it is least absorbent of the IR at the center near the aperture and more effective at the outer part of the layer closer to the edge of the larger visible light aperture.

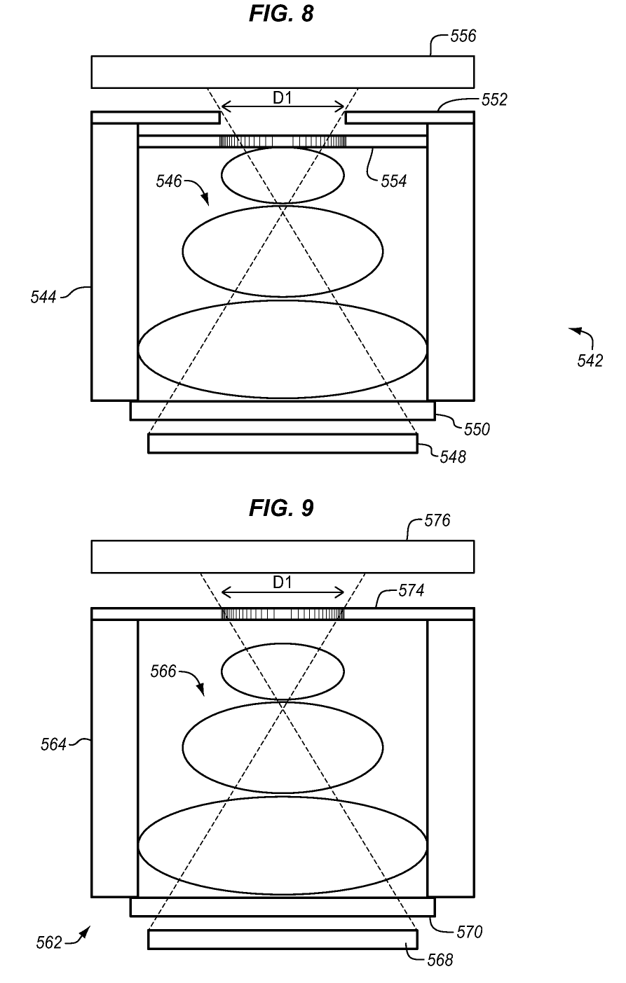

FIG. 9 is a side view diagram of a camera module similar to that of FIG. 7 in which both apertures are in a single aperture mask with an apodized coating. The camera module has a lens system 566 to image a scene through a pass filter 570 and onto an image sensor 568. These are held in place by a housing 564 of the camera module 562. An LC filter 576 is mounted over the lens between the lens and the scene to selectively allow either the visible light, the IR light, or both into the lens system. In this case, the large and small apertures are integrated onto a single substrate 574 similar to that of FIG. 4.

This single aperture mask substrate is coated up to a first larger diameter with a material that absorbs visible and IR light. Within the larger aperture, a second material is applied that absorbs IR light and allows IR light to pass only through a second smaller aperture. The IR absorbing material may be applied in a gradually thickening or more effective layer so that it is most absorbent of the IR at the outer part of the layer near the edge of the first aperture. It then becomes less absorbent toward the center of the aperture mask. In this way an apodized smaller aperture may be provided.

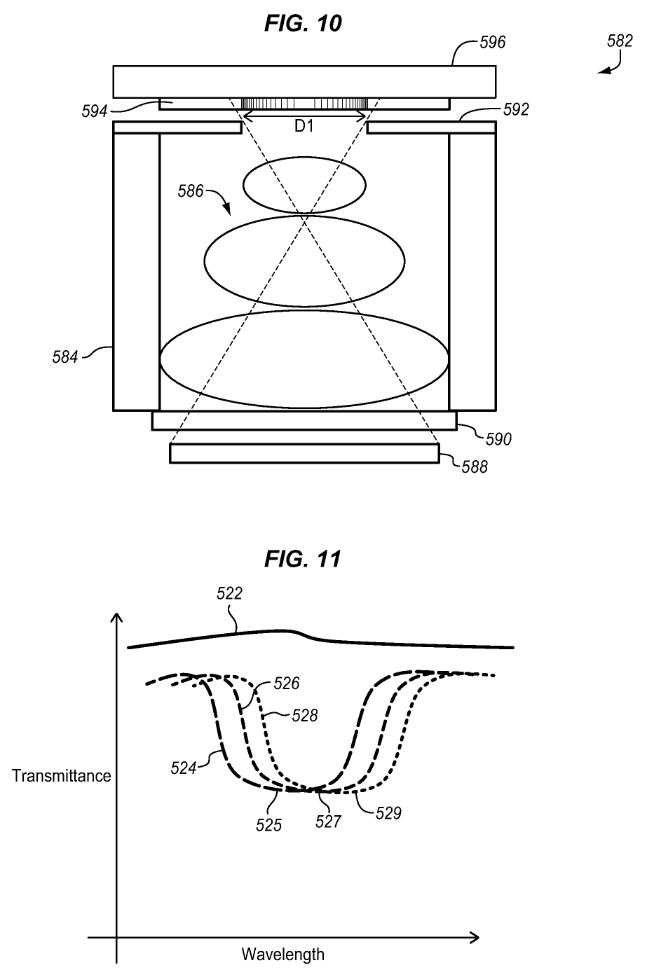

FIG. 10 is a side view diagram of an alternative camera module in which one of the two apertures is formed on the same substrate with the LC filter. In this example, a housing 584 is covered with a substrate that carries the LC film 596 for selecting whether visible, IR or both types of light will pass through the film to the image sensor. A smaller IR filter 594 is formed on the substrate for the LC film. The aperture is shown as an apodized aperture formed by a coating with a smaller aperture for the IR light. The coating that forms the aperture is transparent to visible light but absorbs IR light as discussed above. The coating is transparent to IR light through a smaller aperture with diameter D1. An additional larger aperture mask 592 is applied over the housing 584 for visible light. The housing 584 also carries a lens system 586, pass filter 590 and image sensor 588 to form the complete camera module. This example also shows that the either the IR aperture mask of the RGB aperture mask may be mounted closest to the scene. The system operates with either filter on top of the stack. Similarly, the LC film may be above or below or between the aperture masks.

While only the IR aperture mask 594 is formed on the LC film substrate 596, the RGB aperture mask 592 may also be formed on the LC substrate. The RGB mask may be formed by a simple opaque coating applied to the top or the bottom of the substrate with an opening for all wavelengths.

As shown and described, any of the various dual aperture systems described herein may be combined with a controllable LC filter. The aperture masks may be clear or apodized. Apodization is particularly helpful with the small IR aperture. The visible light aperture may also be apodized. The aperture masks may be separate or formed on a single aperture mask. The apertures may be formed by cutting an opening in a solid material or by applying coatings to a solid material that covers the lens system. As mentioned above, a single substrate with a central small hole may be used as the small aperture mask and then coated with an appropriate material to form a small IR aperture and a larger visible light aperture. With the LC filter in place, the substrate of the LC filter may also be used as a substrate upon which either the visible light aperture, the IR light aperture or both may be formed by coating, layering, or cementing.

FIG. 11 is a diagram of a response of different LC films as a function of an applied control voltage. The wavelength of the transmitted light is on the horizontal axis and the transmittance of the LC film is on the vertical axis. A first upper curve 522 shows an almost level amount of transmittance for all light wavelengths when no control voltage is applied. The transmittance is not 100% but it is high enough that the substrate with non-activated films may be used over a small camera module.

For each of three different film compositions, a different color response is obtained when the film is enabled. A first blue reflecting film has a response curve 524 for shorter wavelengths that has a lower well 525 to block virtually all of the shorter wavelength visible light. The well or floor is not broad enough to block all visible light and, in particular not the longer wavelength red light. The filtering effect is by reflectance. Accordingly, by placing the LC filter outside of or near the outside of the housing, the reflections are prevented from entering the lens system housing. A second green reflecting coating has a response curve 526 with a floor 527 when enabled that does not extend as far into the shorter wavelengths but extends farther into the red wavelengths. A red reflective coating has a response curve 528 that extends still farther into the longer red wavelengths but does not reflect very much of the blue light.

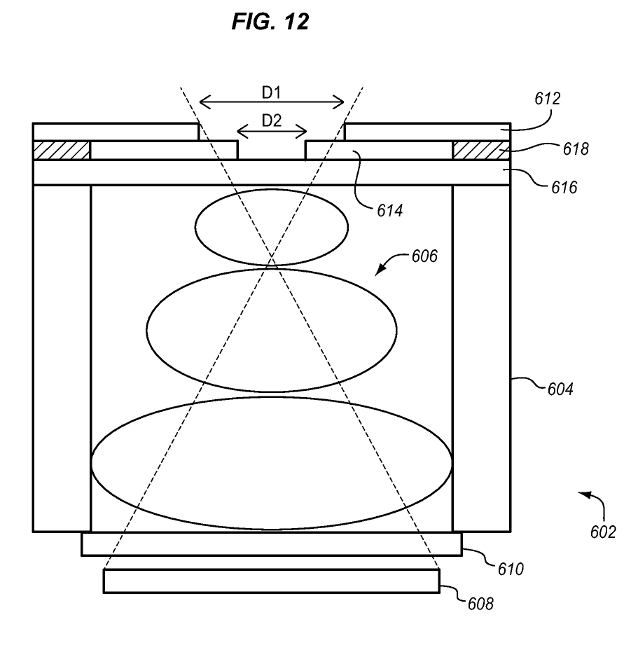

The response of an LC film is typically a function of an applied control voltage. Visible light may be filtered out by using films with a strong reflectance or by applying a strong control voltage. For a greater effect, more films of the same type may be layered or the film may be made thicker. As shown, the full visible light is better covered by using two or more films layered one over the other so that all of the light is reflected at the level of the floor of the response curves in FIG. 12. There may be several LC film layers on top of each other and they may have the same or different reflectance bands in a 400 nm-850 nm range. An additional LC film may be used for the IR band. This IR band film may be activated separately from the color LC films. In this way the system may select whether to allow only visible, only IR, both or neither by applying a control voltage to one or both of the LC films.

The controllable reflectance allows the LC film material to be used as a spectrum selective switchable IR cut filter. The selectivity is improved for the system by combining the selectivity of the LC film with the selectivity of an RGB+IR bandpass filter as shown and described above. LC films are usually not able to be tuned as precisely as dedicated constant filter coatings. The precision of the bandpass filter helps to ensure that only the desired visible and IR wavelengths reach the image sensor.

A liquid crystal film provides good performance at a low price and low voltage for the purposes and structures described herein. As an alternative, an electro-chromatic filter or electrochromic filter may be used to seal the camera module and provide the same or a similar function. When the camera is used for selfies, the electro-chromatic filter may be set to pass the visible light (RGB) and when only IR is needed, for example for iris recognition, the electro-chromatic filter may be controlled in a way that it only passes IR light. As with the LC filters, an RGB+IR dual band pass filter may be used to do accurate and steep filtering.

While LC materials are well developed and readily available for displays, electro-chromatic or electrochromic materials are readily available for window and mirror glass. Some electrochromic materials are designed to provide privacy or to reduce night time glare by darkening the glass when a voltage is applied. Another type of electrochromic material is designed to provide heat regulation by blocking infrared light on hot days and transmitting it on cold days. While these materials typically offer only one type of filtering characteristic, two materials may be applied to the same piece of glass. Alternatively two pieces of glass, one for visible light and another for infrared light may be cemented together. Typical electrochromic structures use an electrochromic liquid or gel captured between two layers of transparent substrate, such as glass or plastic. Electrodes allow a potential to be applied to the liquid or gel to achieve the desired effect.

An electro-chromatic or electrochromic filter may be applied to any of the different described embodiments to provide similar functions. Like the LC filter, the electro-chromatic filter may have more than one layer to provide functionality for different wavelength bands. A composite electro-chromatic or electrochromic (EC) filter may have two layers of electrochromic materials, one to switch between passing or rejecting IR light and the other to switch between passing or rejecting RGB light. The two layers may be activated independently of each other and use different materials optimized for each function.

Using commonly available electro-chromatic films, visible light can be filtered out up to a wavelength as high as 700 nm. This is much shorter than the 820 nm that is commonly used for iris recognition. Accordingly, these films will not interfere with any of the light from the IR LED that is used for iris recognition. As with the LC filter, one or more electro-chromatic materials may also be used as a spectrum selective switchable IR cut filter.

FIG. 12 is a side view diagram of an alternative camera module with a cemented electro-chromatic composite sheet 616. The camera module 602 has a housing 604 to carry a lens system 606, an image sensor 608, and an optional RGB and IR pass filter 610. The housing is sealed with an electro-chromatic composite filter 616. This filter has an RGB material and an IR material between transparent sheets cemented together and applied over the lens system on the end of the housing. The filter is controlled by a controller of the camera module or a separate ISP to activate either or both of the two materials by applying a controlled voltage to appropriate contacts. More materials may be used for additional control purposes or to extend the wavelength range of the filter. In addition, an LC filter may be used together with an electro-chromatic filter to provide filtering for different wavelengths.

The composite filter 616 is retained to the end of the housing 604 by a sealing or retaining ring 618. Aperture masks are attached over the top of the composite filter. In this example, a smaller IR aperture mask 614 is applied to a sheet and attached over the top of the composite filter. This IR aperture mask may be made in any of the ways described herein but is attached on the opposite side of the composite filter from the lens system. A large aperture mask 612 is mounted over the IR aperture mask. This may be a separate substrate or a mask may be applied directly to the IR mask. In one example a black tape or coating is applied over the IR aperture mask to form a larger aperture for visible light.

While an electro-chromatic filter is shown, an LC filter may be used instead. Similarly, an electro-chromatic filter may be used instead of an LC filter in any of the other described examples. In addition, LC and electro-chromatic elements may be combined in a single composite system.

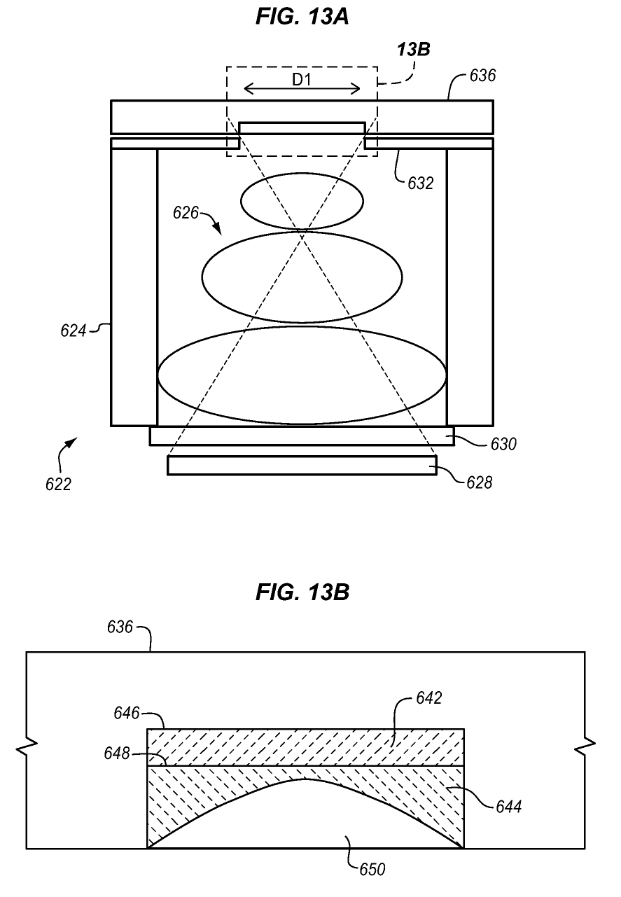

FIG. 13A is a side view diagram of an alternative camera module in which both aperture masks are formed on the substrate for the EC filter. In this example, the camera module 622 has a housing to retain the lens system 626, the pass filter 630 and the image sensor 628. The housing is sealed at one end with the EC filter 636. There may be a large aperture mask 632 to define the maximum visible light aperture or this may incorporated into the EC element 636.

FIG. 13B is an enlarged view of the EC element 633 of FIG. 13A. An apodized IR aperture mask is formed on one side of the EC filter substrate using an EC material 644 that absorbs IR light. The material is enclosed by a shaped transparent plastic part 650 that defines a chamber for the EC material 644. In some embodiments, the activated electrochromic material 644 and the shaped plastic chamber wall 650 have the same or a very similar index of refraction. The chamber is smaller or narrower in the middle and larger or wider on the sides. This is a Gaussian shape in this example, so that the IR transmission intensity distribution is Gaussian. There is an additional control layer 648 to apply a controlled voltage and frequency to the EC material 644.

There is another layer of EC material 642 in another chamber to reflect or absorb incoming light. By adjusting the voltage and frequency, this layer may be used to block all visible or all IR light. A control layer 646 may be used to control the applied voltage and frequency. The complete structure 636 is therefore both a visible/IR switch and a switchable apodized IR mask in a single composite, multiple layer structure. The EC material in both sections 642, 644 may be the same or different. The electrical bias signals may be provided by a controller (not shown) that is integrated into the camera module or by a separate controller.

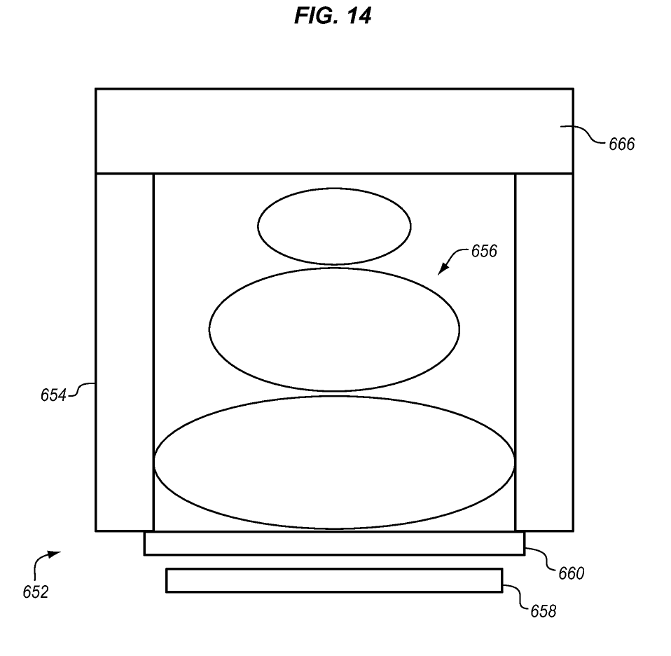

FIG. 14 is a side view diagram of a further alternative camera module 652 in which an EC or LC element 666 is configured to switch the module between visible light and IR light imaging. The module has a camera housing 654 with an image sensor 658 capable of capturing either visible or IR images or both. An optional RGB+IR filter 660 is between the image sensor and a scene to be imaged to restrict the light wavelengths that may impinge on the sensor. A lens system 656 within the housing images the scene onto the sensor.

An EC or LC element 666 is placed over the housing 654 which acts as a tunable IR cut filter. The filter passes either visible or IR light, but not both, depending on the mode of the camera. The filter is controlled by an external controller such as the ISP 104 of FIG. 1 or by a separate camera module controller (not shown). By cutting the visible light only IR is allowed to pass. This puts the camera in a mode for imaging a user iris or another subject using IR light. By cutting the IR light the camera is able to capture visible light more accurately. This puts the camera in a mode for imaging scenes with the color perceived by a user. The two filtering effects may be accomplished using two layers or by using a single layer with different control voltage and frequencies applied. Alternatively, the EC or LC element may be used only to block visible light for IR imaging. Other techniques may be used to filter IR light from the visible light images.

The camera module may also include fixed aperture masks as shown in other figures with either clear or apodized apertures. The EC or LC element may also incorporate a visible or IR mask or both as described in the context of the other embodiments above.

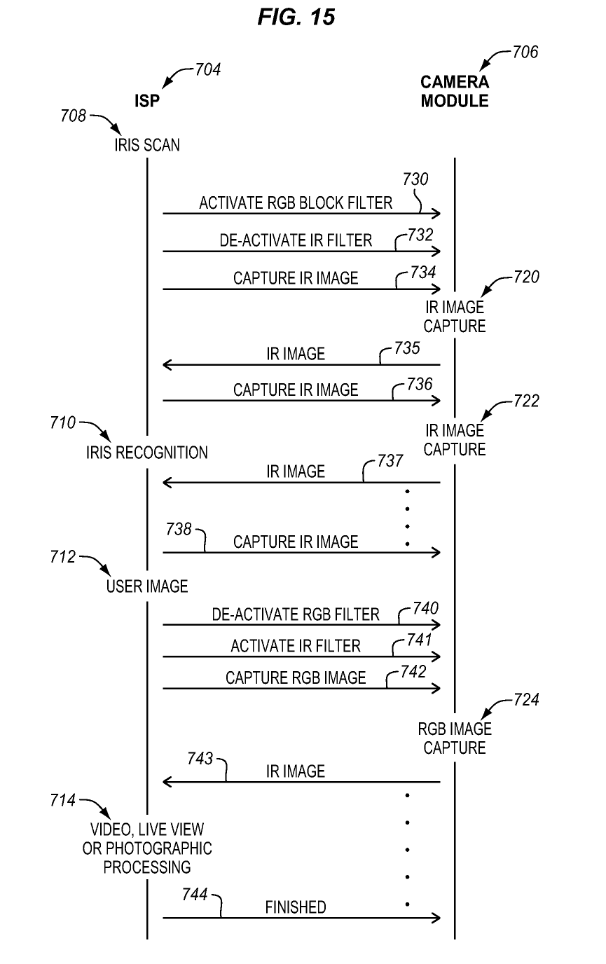

FIG. 15 is a process flow diagram of interactions between a controller or image signal processor and a camera module or camera system. The diagram shows two ISP modes, iris recognition and visible light imaging. The ISP 704 or other controller has a variety of different operational modes. These include an iris scan or infrared imaging mode 708 and a user image mode 712. The user image mode may be used as a selfie mode, a video conferencing mode, a self-portrait mode, or it may go by other names. There may be different modes for each of these and for other applications. These modes may be entered based on environmental sensor inputs or based on user commands to a user interface of the device.

In the iris scan mode 708. The ISP sends commands to the camera module 706 to activate a visible light or RGB blocking filter 730 and to deactivate an IR light blocking filter 732. These commands may or may not be necessary depending on the current state of these filters. The camera module responds to these commands by changing or setting the control voltage applied to a controllable filter. As explained above, such a filter may be a liquid crystal filter, an electro-chromatic filter, a combination of these two types, or another type of controllable filter. The filter states may be changed by the camera module or by another component. The ISP may be any controller that causes the camera module to take images.

After the filters are set, the ISP commands that an IR image be captured 734. The camera module responds by entering an IR image capture mode 720 and captures an IR image on its image sensor. There may be one or more captured images. In some systems, two or more images are always captured for iris recognition, in which case, the module may capture the two or more images without any further commands from the ISP. The image capture mode may require the camera module to operate a flash or other illumination, to operate a shutter, to operate sample and hold circuits, and to perform other operations.

After capturing one or more IR images, the camera module sends the captured images back to the ISP 735. The ISP is in an iris recognition mode 710 and may evaluate these images 710 and then determine whether the images are sufficient for iris recognition. If so then the process is finished and the ISP instructs 737 the camera module accordingly. In the iris recognition mode 710, the ISP may determine that the iris images are not sufficient to allow the iris to be recognized. This may occur because the iris does not belong to a registered user or it may be because of a problem in the way the image was captured. The ISP may require another IR image capture 736. The camera module may then return to an IR image capture mode 722 to capture more IR images and then send these to the ISP 737.

After the iris recognition process is finished, the ISP may inform the camera module that the process is finished 738. The camera module may then enter a power saving mode by deactivating the controllable filters, turning off the image sensors and performing other power saving tasks. If there are other tasks awaiting operation at the camera module, then these may be performed in turn.

At 712 the ISP may enter a user image, selfie, or video conference mode. This mode may be after or before the iris scan mode. In this mode the ISP sends commands to the camera module to deactivate the RGB filter 740 to allow visible light to pass, to optionally activate the IR filter 741 to block IR light, and to capture one or more RGB images 742. The camera module may then enter an RGB image capture mode 724 and capture one or more images. These images are returned to the ISP 743. The ISP may then process the one or more images 714 and, after this is completed, send a command 744 to finish the visible image capture mode. The camera module may then enter a low power mode as before or remain ready for another image capture mode for visible light.

The images in the user image mode may be frames of a video sequence for video conference or for recording. The images may be still images, such as user portraits. In some embodiments, the device may provide a live view feature for the still images. For live view, the display shows the view of the camera as an active live display. The image display changes as the camera position and subject change. When the user is satisfied with the presented view, then the user can command the system to capture an image. For such a mode, the camera module presents a video sequence of frames to the ISP to present on the display. The frames are buffered for display but only the captured frame is stored for later recovery.

These operations are provided as examples only. More or fewer operations may be added. There may be additional operations to support camera flash, system audio, different image capture modes, etc.

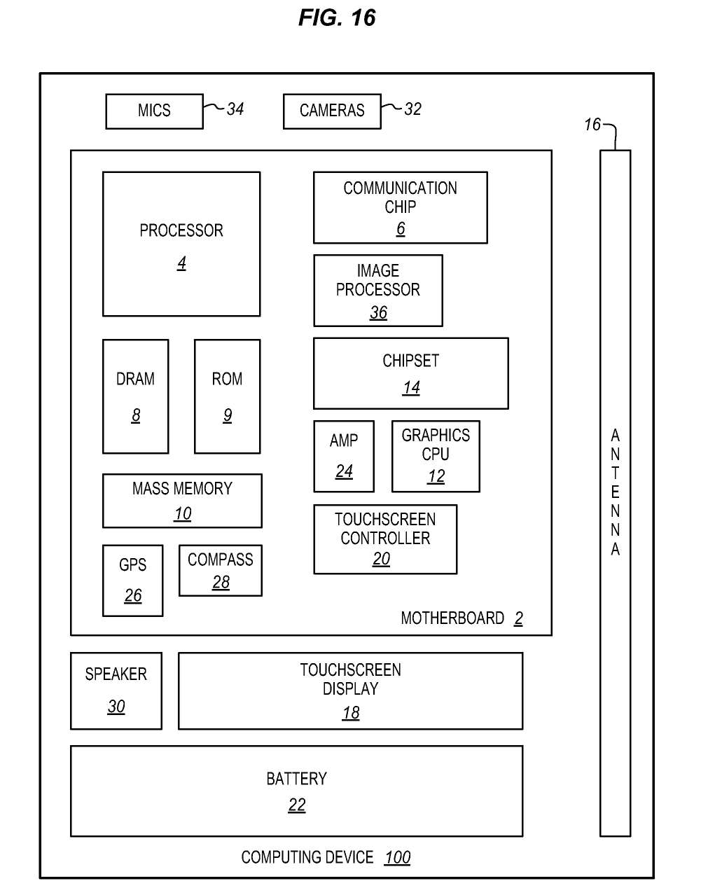

FIG. 16 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 including any depth sensors or proximity sensor are coupled to an optional image processor 36 to perform conversions, analysis, noise reduction, comparisons, depth or distance analysis, image understanding and other processes as described herein. The processor 4 is coupled to the image processor to drive the process with interrupts, set parameters, and control operations of image processor and the cameras. Image processing may instead be performed in the processor 4, the cameras 32 or in any other device.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to an apparatus that includes an image sensor to image visible and infrared light, a lens system to image a scene onto the image sensor, and an electrically activated filter that selectively prevents visible light from the scene from impinging on the image sensor while capturing an infrared image.

Further embodiments include a second electrically activated filter that selectively prevents infrared light from the scene from impinging on the image sensor while capturing a visible light image.

In further embodiments, the first and the second electrically activated filters comprise a liquid crystal filter.

In further embodiments, the first and the second electrically activated filters comprise a single electrochromic material.

Further embodiments include an infrared aperture mask having an aperture to allow infrared light to pass from the scene to the image sensor, the infrared aperture mask being transparent to visible light.

In further embodiments, the infrared aperture mask is formed of an electrochromic material and is selectively activated for infrared imaging.

In further embodiments, the electrochromic material is thinner near the center of the aperture and thicker near the edge of the aperture to produce an apodized aperture.

In further embodiments, the electrically activated filter is a three layer composite filter having three different liquid crystal materials, each material for preventing light of different wavelengths from the scene from impinging on the image sensor.

Some embodiments pertain to an apparatus that includes an image sensor to image visible and infrared light, a lens system to image a scene onto the image sensor, a first aperture mask having a first aperture to allow visible light to pass from the scene to the image sensor, and a second aperture mask having a second aperture that is smaller than the first aperture to allow infrared light to pass from the scene to the image sensor.

In further embodiments, the first and the second aperture mask are formed from a single substrate.

In further embodiments, the first aperture mask comprises an opaque material having a circular hole to form the first aperture.

In further embodiments, the second aperture mask comprises a transparent substrate with a coating that prevents infrared light and allows visible light to pass through the coating to the image sensor.

In further embodiments, the lens system has a fixed focus distance and wherein the depth of field for infrared light through the second aperture is larger than for visible light through the first aperture.

In further embodiments, the lens system has a focus distance selected for video conferencing and the depth of field for infrared light includes a shorter distance selected for iris recognition.

In further embodiments, the lens system is between the first and second aperture masks on one side and the image sensor on an opposite side.

Further embodiments include an electrically activated filter that when activated prevents visible light from the scene from impinging on the image sensor.

Further embodiments include an electrically activated filter that when activated prevents infrared light from the scene from impinging on the image sensor.

In further embodiments, the electrically activated filter is a liquid crystal filter.

In further embodiments, the electrically activated filter is a three layer composite filter having three different liquid crystal materials, each material for preventing light of different wavelengths from the scene from impinging on the image sensor.

In further embodiments, the electrically activated filter is an electrochromic filter.

In further embodiments, the electrically activated filter is between the lens system and the first and second aperture masks on one side and the scene on an opposite side.

In further embodiments, the image sensor comprises an array of photodetectors each having an associated color filter and wherein the color filters comprise red, green, blue, and infrared filters.

Some pertain to a method that includes activating a visible light filter to block visible light from impinging on an image sensor of a computing device, capturing an infrared image of a scene through a lens system and an infrared aperture mask by the image sensor of the device, and deactivating the visible light filter to allow visible light to pass through the filter and impinge on the image sensor of the computing device.

In further embodiments, the scene comprises an iris of a user, the method further comprising performing iris recognition using the captured scene.

Further embodiments include deactivating an infrared light filter before capturing the infrared image of the scene.

Further embodiments include performing iris recognition using the captured infrared image.

Further embodiments include activating an infrared light filter to block infrared light from impinging on the image sensor after capturing an infrared image of the scene and capturing a visible light image of the scene after activating the infrared light filter.

Some embodiments pertain to a computing system that includes a system board, a processor attached to the system board, a memory attached to the system board and coupled to the processor, and a camera module coupled to the processor, the camera module having an image sensor to image visible and infrared light, a lens system to image a scene onto the image sensor, and an electrically activated filter that selectively prevents visible light from the scene from impinging on the image sensor while capturing an infrared image.

In further embodiments, the camera module further comprises a second electrically activated filter that selectively prevents infrared light from the scene from impinging on the image sensor while capturing a visible light image.

Further embodiments include an infrared aperture mask having an aperture to allow infrared light to pass from the scene to the image sensor, the infrared aperture mask being transparent to visible light.

In further embodiments, the infrared aperture mask is formed of an electrochromic material and is selectively activated for infrared imaging.

In further embodiments, the camera module further comprises a visible light aperture mask having a second aperture that is larger than the infrared aperture to allow visible light to pass from the scene to the image sensor while capturing a visible light image.

In further embodiments, the lens system has a fixed focus distance and wherein the depth of field for infrared light through the second aperture is larger than for visible light through the first aperture.

What is claimed is:

1. An apparatus comprising:
an image sensor to image visible and infrared light;
a lens system to image a scene onto the image sensor; and
an electrically activated filter that selectively prevents visible light from the scene from impinging on the image sensor while capturing an infrared image.

2. The apparatus of claim 1, further comprising a second electrically activated filter that selectively prevents infrared light from the scene from impinging on the image sensor while capturing a visible light image.

3. The apparatus of claim 2, wherein the first and the second electrically activated filters comprise a liquid crystal filter.

4. The apparatus of claim 1, further comprising an infrared aperture mask having an aperture to allow infrared light to pass from the scene to the image sensor, the infrared aperture mask being transparent to visible light, wherein the infrared aperture mask is formed of an electrochromic material and is selectively activated for infrared imaging.

5. The apparatus of claim 4, wherein the electrochromic material is thinner near the center of the aperture and thicker near the edge of the aperture to produce an apodized aperture.

6. The apparatus of claim 1, wherein the electrically activated filter is a three layer composite filter having three different liquid crystal materials, each material for preventing light of different wavelengths from the scene from impinging on the image sensor.

7. An apparatus comprising:
an image sensor to image visible and infrared light;
a lens system to image a scene onto the image sensor;
a first aperture mask having a first aperture to allow visible light to pass from the scene to the image sensor; and
a second aperture mask having a second aperture that is smaller than the first aperture to allow infrared light to pass from the scene to the image sensor.

8. The apparatus of claim 7, wherein the first and the second aperture mask are formed from a single substrate.

9. The apparatus of claim 7, wherein the lens system has a fixed focus distance and wherein the depth of field for infrared light through the second aperture is larger than for visible light through the first aperture.

10. The apparatus of claim 7, wherein the lens system is between the first and second aperture masks on one side and the image sensor on an opposite side.

11. The apparatus of claim 7, further comprising an electrically activated filter that when activated prevents visible light from the scene from impinging on the image sensor.

12. The apparatus of claim 11, wherein the electrically activated filter is a multiple layer composite filter having different liquid crystal materials, each material for preventing light of different wavelengths from the scene from impinging on the image sensor.

13. A method comprising:
activating a visible light filter to block visible light from impinging on an image sensor of a computing device;
capturing an infrared image of a scene through a lens system and an infrared aperture mask by the image sensor of the device; and
deactivating the visible light filter to allow visible light to pass through the filter and impinge on the image sensor of the computing device.

14. The method of claim 13, wherein the scene comprises an iris of a user, the method further comprising performing iris recognition using the captured scene.

15. The method of claim 13, further comprising deactivating an infrared light filter before capturing the infrared image of the scene.

16. The method of claim 13, further comprising performing iris recognition using the captured infrared image.

17. The method of claim 13, further comprising activating an infrared light filter to block infrared light from impinging on the image sensor after capturing an infrared image of the scene and capturing a visible light image of the scene after activating the infrared light filter.

18. A computing system comprising:
a system board;
a processor attached to the system board;
a memory attached to the system board and coupled to the processor; and
a camera module coupled to the processor, the camera module having an image sensor to image visible and infrared light, a lens system to image a scene onto the image sensor, and an electrically activated filter that selectively prevents visible light from the scene from impinging on the image sensor while capturing an infrared image.

19. The system of claim 18, further comprising an infrared aperture mask having an aperture to allow infrared light to pass from the scene to the image sensor, the infrared aperture mask being transparent to visible light.

20. The system of claim 19, wherein the camera module further comprises a visible light aperture mask having a second aperture that is larger than the infrared aperture to allow visible light to pass from the scene to the image sensor while capturing a visible light image.
